(19) United States
(12) Patent Application Publication
(10) Pub. No.: US 2025/0260710 A1
(43) Pub. Date: Aug. 14, 2025

(54) Method for Automating Security Architecture Reviews and Assessments

(71) Applicant: Mary KAO, Leesburg, VA (US)

(72) Inventor: Mary KAO, Leesburg, VA (US)

(21) Appl. No.: 19/194,720

(22) Filed: Apr. 30, 2025

Related U.S. Application Data
(63) Continuation of application No. 18/624,274, filed on Apr. 2, 2024.
Application No. 18/624,274 is a continuation of application No. 17/461,546, filed on Aug. 30, 2021, now abandoned.
(60) Provisional application No. 63/071,883, filed on Aug. 28, 2020.

(51) Int. Cl. H04L 9/40

(52) U.S. Cl. CPC H04L 63/1433

(57) ABSTRACT

Various embodiments include software tools that may be used to automate cybersecurity assessments and reviews of IT systems and applications in the context of their operational environments. Various embodiments include a software tool that leverages a project management tool as a foundation and implements and adds to the project management tool extended features, functions, methods, and capabilities that enable the software application to be used in performing and automating cybersecurity assessments and reviews. Various embodiments leverage the use of the project management tool as a foundation on which to build and extend its features and capabilities and methods to produce the end result of a software tool for use in the finance and banking industry. Various embodiments may be useful as a cybersecurity assessment tool for an organization's system and applications, and their operating environments, and the organization's IT projects.

### RELATED APPLICATIONS

This application is a Continuation Application of U.S. Non-Provisional patent application Ser. No. 18/624,274 entitled “Method for Automating Security Architecture Reviews and Assessments” filed on Apr. 2, 2024, which is a Continuation of U.S. Non-Provisional patent application Ser. No. 17/461,546 entitled “Methods and Systems for Automating Cybersecurity Reviews of IT Systems, IT Assets, and Their Operating Environments” filed Aug. 30, 2021 which claims the benefit of priority to U.S. Provisional Application No. 63/071,883 entitled “Software Tool for Automating Cybersecurity Assessment and Review of IT Systems, Applications, and Their Operating Environments” filed Aug. 28, 2020, the entire contents of both of which are hereby incorporated by reference for all purposes.

### BACKGROUND

Within the banking and finance industry, there exists a systemic problem attributed to the disparate nature of the organization structure of these types of firms, companies, and corporations. For example, within a banking corporation, there may exist branches, subsidiaries, third party partners, contractors, temporary workers, and guests for which all of the enterprise's information technology (IT) assets and resources must be reviewed, audited, and ensured to be compliant with regulations in order to operate within a company's premises, whether virtual or physical. The enterprise's resources and information and the information of individuals and customers must be protected. Such large enterprises often inherently carry the systemic issues of silos of repeating information and IT resources, and often many manual processes for managing its IT assets and resources, and conducting the needed compliance reviews and audits. Conducting a security review using an enterprise-central approach or other disparate organization specific approaches often relies on established manual processes that can be labor intensive and time and resource intensive. Such systemic issues can be labor intensive, time consuming, and resource intensive to work with.

### SUMMARY

Various embodiments include a software tool that can be used to automate cybersecurity assessments and reviews of IT systems and applications, in the context of their operational environments. Various embodiments include a software tool that leverages a project management tool as a foundation and implements and adds to the project management tool extended features, functions, methods, and capabilities that enable the software application to be used in performing and automating cybersecurity assessments and reviews. Various embodiments leverage the use of the project management tool as a foundation on which to build and extend its features and capabilities. Various embodiments further include methods to produce the end result of a software tool for use in the finance and banking industry. Various embodiments may be useful as a cybersecurity assessment tool for an organization's system and applications, and their operating environments, and the organization's IT projects. Conducting a security review using an enterprise-central approach a security review assessment tool according to various embodiments can result in cost savings to an organization.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a component block diagram illustrating an example system architecture and its deployment as a central service in an enterprise according to various embodiments.

FIG. 1B is a component block diagram illustrating further details regarding of how various embodiments may be deployed in a more localized or personal environment.

FIG. 2A is diagram showing some of the difference between a project management tool and a customized assessment tool according to various embodiments.

FIG. 2B is a data structure diagram illustrating an example of datasets suitable for implementing various embodiments.

FIG. 3 is a process flow diagram showing an example automation flow of a review cycle which the system provides as a set of detailed workflows.

FIG. 4 is a workflow diagram that may be used for conducting a basic standard security review according to various embodiments.

FIGS. 5A and 5B are a system level architecture diagram suitable for implementing various embodiments.

FIG. 6A-6C are workflow diagrams illustrating work flow by a project management tool for demonstrating differences between underlying technology and an assessment tool according to various embodiments.

### DETAILED DESCRIPTION

Various embodiments may be described in detail with reference to the accompanying drawings. References made to particular examples and embodiments are for illustrative purposes, and are not intended to limit the scope of the claims.

Various embodiments include a set of extended, enhanced, features, functions, methods, and capabilities of a project management tool. Currently such capabilities do not exist in a project management tool used for managing projects, managing tasks, measure project and task performance. Cloud hosted versions of known in Software as a Service (SaaS) systems cannot offer a service consumer the same extent of control over the software system by nature due to the fact that it resides in the service provider's operational environment. Some practical outcomes and benefits for organizations utilizing this tool.

Organizations conducting IT security reviews may use various embodiments to bring order and efficiency to the review process, time savings which translates into time and money savings, compared to conducting IT security review using manual processes. Various embodiments reduce the complexity of tracking, examining, and making a determination on the outcome of the security assessment, based on the information needed to conduct the examination and reviews of an organization's IT systems and applications. Various embodiments can serve as a central repository for the needed information, specifically in relation to the security architecture and security design of the item under consideration, and to help facilitate the assessment of said security provisions in the concerned system or application or enterprise asset.

Various embodiments better enable organizations to employ and implement an enterprise Risk Management Strategy which involves the use of security controls that require and specify use of Enterprise Architectures (EA), Enterprise Information Security Architectures (EISA), and system level Information Security Architectures (ISA). There are security controls within the cyber industry which recognize EA and EISA and ISA as the actual security controls.

Various embodiments can generate the information and data necessary in determining the effectiveness of an organization's information security architectures, have these controls been effectiveness in the overall improvement of the organization's security posture, through means of reduced risks and vulnerabilities due to the use and application of said security architectures.

Various embodiments may provide a ready-made system of record where it is recorded that a particular project's IT systems and resources has successfully undergone an examination of its security related capabilities and functions. Once the cybersecurity assessment and review has been completed, the data resides in and remains in the tool database and can serve as an official case record or System of Record (SOR) of the examination and results. That information can continue to be accessed post-review, as needed and as often as needed.

Various embodiments may be useful in the banking and finance industry. Various embodiments may be of benefit by bring order to chaos in such industries due to the challenges and complexities in their IT and processes that are driven by organizational complexities. Such complexities are made more challenging by the active employment of cybersecurity protections, and the work of cybersecurity assessments and reviews and audits of those protections and security requirements. The banking and finance industry's enterprise environment is not a single controlled environment, but rather there could be subsidiaries, branches, third party business partners, contractors, temporary workers, and guests all coexisting at any given time. The vast and varied amounts of IT and data and information can also be quite dispersed and varied, which can lead to high security risks. As a result, there is an increased need to conduct cybersecurity assessments and reviews of the enterprise IT systems, applications, assets, technologies, data, and information. In this environment, the types of hardware and software that need to undergo examination include servers, desktops, laptops, network appliances, mobile devices, operating systems, applications, files, routers, firewalls, switches. All these may involve security protections such as access controls, network access restrictions, network monitoring, secure data transmission and storage, customization and enhancements management, user activity monitoring. This industry is also very active in the area of IT auditing, which various embodiments can facilitate, especially in the inspection of the effectiveness of an organization's enterprise architecture, information security architecture, system information security architecture, the system as a whole, applications, IT items, and the operating environment.

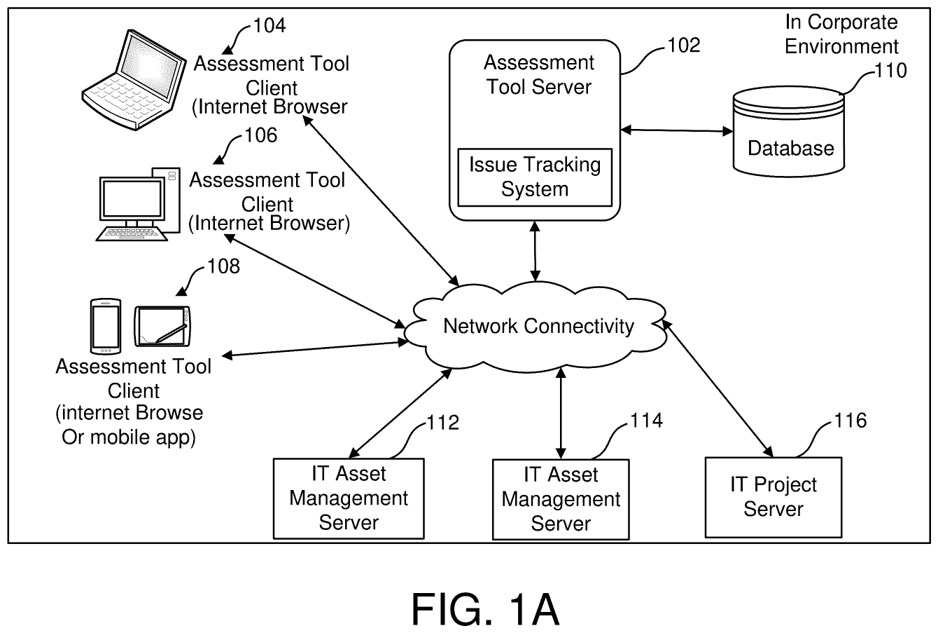

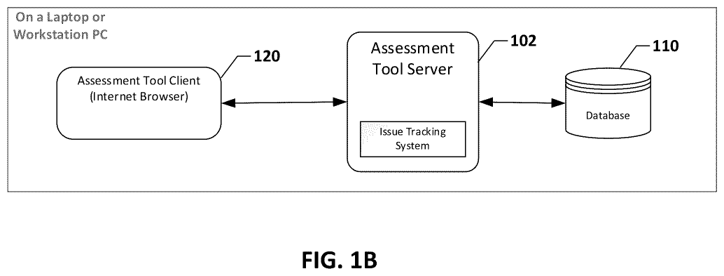

FIG. 1A is a diagram of major system components that may be implemented in various embodiments for use within the larger enterprise environment. An assessment tool according to various embodiments may be a client/server web based application, which can be run within a larger corporate environment with components on separate hardware. An assessment tool client component is a web browser running on a laptop, workstation pc, or mobile device. The client component can also be a mobile app running on a mobile device. An assessment tool according to various embodiments, as shown, may be used in entirety as a dedicated application only for performing cybersecurity assessments and reviews of IT systems and applications. The nature of examinations which the tool may be used for is in the context of security architecture and design, to make a determination of assessment outcome.

Various embodiment improving systems and methods for performing security reviews by enabling the implementation of numerous datasets necessary for conducting an enterprise system to successfully undergone an examination of its security related capabilities and functions without having to require the traditional database modeling and design aspects of implementing.

FIG. 1A shows the “Assessment Tool Server” 102 as centrally accessible via the enterprise's network. This central server may be accessed from a user's laptop 104, desktop workstation 106, and/or mobile devices 108. The central server 102 has a backend database 110 where review data and records may be stored. The central server 102 may integrate with and retrieve information from other enterprise systems such as an IT asset management server 112, an IT vendor management server 114, and/or an IT project server 116.

In various embodiments, an assessment tool may also interact with such the other systems illustrated in FIG. 1A to include asset management system, project management system, a vendor management system, and other enterprise systems which house the compliance life cycle and other life cycles (see use cases) as these often house needed information for security reviews. Various embodiments may auto-populate relevant data from these other servers into a review form.

FIG. 1A illustrates the assessment tool as a client/server web-based application, which can be run within a larger corporate environment with components on separate hardware, The assessment tool's client component may be a web browser running on a laptop, workstation pc, or mobile device. The client may also be a mobile app running on a mobile device.

When run, an assessment tool according to various embodiments may be used in entirety as a dedicated application for performing cybersecurity assessments and reviews of IT systems, applications, and their operating environments, in the context of examination of the items security architecture and security design to make a determination of assessment outcome. The assessment tool though built on a foundational issue tracking system that performs general project management and task management, will not be employed in the context of project management and task management but will be dedicated to cybersecurity assessment and reviews. Conventional issue tracking systems foundationally are used for multiple uses (project management, task management, process management), whereas software tools of various embodiments will be used for only a single purpose-conducting cybersecurity assessments and reviews in relation to the security architecture and security design of the systems, applications, and items under review.

An assessment tool according to various embodiments though built on a foundational project management tool that performs general project management and task management, will not be employed in the context of project management and task management but may be dedicated to cybersecurity assessment and reviews. Additionally, the project management tool foundationally may be used for multiple uses (project management, task management, process management), whereas a software tool according to various embodiments may be used for only a single purpose-conducting cybersecurity assessment and review in relation to the security architecture and security design of the systems, applications, and items under review.

FIG. 1B is a diagram which shows how an assessment tool according to various embodiments may be used as more of a standalone application (entirely on a user's laptop 104 or desktop 106) where all components reside locally on a single laptop or desktop pc environment.

This is how the Cybersecurity Assessment and Review Software Tool (hereafter referred to as “Assessment Tool”) may be used. An assessment tool according to various embodiments may be a client/server web based application, which may be run within a larger corporate environment with components on separate hardware, and it may be run more “standalone” where all components reside locally on a single laptop or desktop pc environment. An assessment tool client component is a web browser running on a laptop, workstation pc, or mobile device. The client may also be a mobile app running on a mobile device.

An assessment tool according to various embodiments, when run, may be used in entirety as a dedicated application, only for performing cybersecurity assessments and reviews of IT systems, applications, and their operating environments, in the context of examination of the items security architecture and security design to make a determination of assessment outcome. An assessment tool according to various embodiments, though built on a foundational project management tool that performs general project management and task management, will not be employed in the context of project management and task management but may be dedicated to cybersecurity assessment and reviews. Additionally, the project management tool foundationally may be used for multiple uses (e.g., project management, task management, process management) whereas various embodiments may be used for only a single purpose-conducting cybersecurity assessment and review in relation to the security architecture and security design of the systems, applications, and items under review.

The following are example use scenarios in which there may be need to conduct an IT security review with which various embodiments may be utilized.

Various embodiments may be useful for conducting security assessments as part of an organization's Software Development Life Cycle (SDLC). A software development life cycle typically is comprised of requirements, architecture, design, implementation, test, and deploy. Typically, the IT security review may be conduction between the test and deploy stages in the cycle to ensure the IT meets the mandated security standards.

Various embodiments may be useful for conducting security assessments as part of an organization's Systems Development Life Cycle (SDLC). A system development life cycle differs from the software cycle, in that it will include a concept of operations, requirements, a preliminary design review, a code design review, verifications mapping of the requirements, and deployment. The IT cyber review could be conducted at an earlier stage such as the preliminary design review and then also later between the verification and deployment stages.

Various embodiments may be useful for conducting security assessments as part of an organization's Systems Engineering Life Cycle (SELC). In an enterprise, often times the systems development life cycle and the SELC are comparable and so the cyber review may be conducted in likewise fashion.

In the process of determining the security effectiveness of a system's architecture, the security aspects of the architecture (or security architecture) may be assessed by testing the security controls set in place. This may involve an assessment of the effectiveness of controls for the enterprise architecture, enterprise information security architecture, and system level information security architecture.

IT Audits in the Banking and Finance Industry may be conducted to determine if there is any risk to an enterprise's IT assets and resources and infrastructure. An assessment tool according to various embodiments would be very useful as it would house the enterprise's IT information for conducting such audits.

An enterprise may wish to conduct risk assessments of its IT assets, resources, and information. An assessment tool according to various embodiments would be very beneficial for implementing enterprise risk management strategy as it would house the needed IT information and review results.

There are two approaches to implementing an assessment tool according to various embodiments using a foundational project management tool described previously and enhancing its capabilities to be able to function as a cyber assessment tool:

One approach involves extending and customizing the functionality of the project management tool without creating a new “Project type”. In this approach, an assessment tool according to various embodiments may be implemented through customization of the individual system features and functions. Given the underlying project management tool, that offers a project type called “Process Management” and which offers a generic workflow, some embodiments may extend the capability of this project type by creating customized workflows needed for conducting the security IT reviews, by adding customized fields to the generic screens. This does not limit or exclude the other foundational project types and they would coexist with the added enhancements.

Another approach involves extending and customizing the functionality of the project management tool by creating a new “Project type” along with all the profile features that make up the functionality of a “Project”, such as issues, workflows, screens, data fields, users, groups, dashboard gadgets, reporting. This option involves changes to the code base. An alternative method for adding the needed enhancements, is to implement a construct called New Project Types, specifically for the use of conducting security IT reviews. These project types include: Standard Review Project Type, Full Review Project Type, and Enhanced Review Project Type. These enhancements are done at the source code level in the underlying project management tool. When a user requests or is assigned to one of these review types, their project's security review is created in an assessment tool according to various embodiments as a project of that review type.

Automation methods of an assessment tool according to various embodiments includes the following: automated workflow of each review process, automation of the organization and management of review data and artifacts, and automation of the data creation. This is all enabled through the use of custom forms which will cause data entered to be housed in the system's database.

Automation of the assessment and review process may be achieved through a combination of software features, which are customized workflows for all review types which are associated with customized screens or forms for use in each phase of the flow, review data embedded into the customized form and thereby naturally becomes associated with each review ticket without the need for additional organization and management. Automated retrieval and outputting of certain information with other enterprise systems as needed.

Workflows may be defined for cybersecurity assessment and review of IT systems, applications, and their operating environments, and examination of architectural and security architectural related information. Three types of workflows may be addressed: comprehensive assessment workflows; basic assessment workflows; and custom assessment workflows. A comprehensive assessment workflow is one in which the fullest extent of information may be examined to make a determination of the outcome. A basic assessment workflow is one in which a minimal set of identified system information may be examined to make a determination. A custom assessment workflow is somewhere in between a basic and a comprehensive workflow.

A software form may contain cybersecurity assessment data fields and to which the computer associates one of the cyber review workflows. As the assessment progresses it will move through the assigned workflow so that both reviewers and project teams alike can further enter needed information towards a successful closure of the review.

Various embodiments may provide a formal system of record (SOR) for review case records. By nature of each IT review being associated with a review ticket, along with the customized forms where data has been input, along with any associated attachments, an assessment tool according to various embodiments becomes the enterprise's SOR (System of Record) for all security reviews.

A centralized deployment installation of the invention tool will enable this repository to be a centralized store of cybersecurity assessment and review information and all review teams use this same tool. Each review is embodied in a single software issue form, and may be viewed as a “case”. All associated communications and files may also be attached with the issue and in totality may serve as the official record for the cyber review.

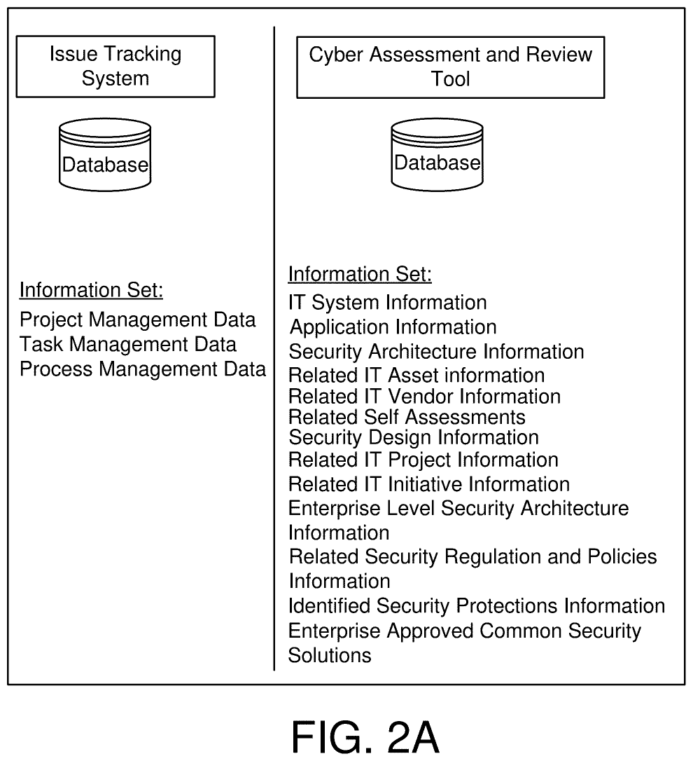

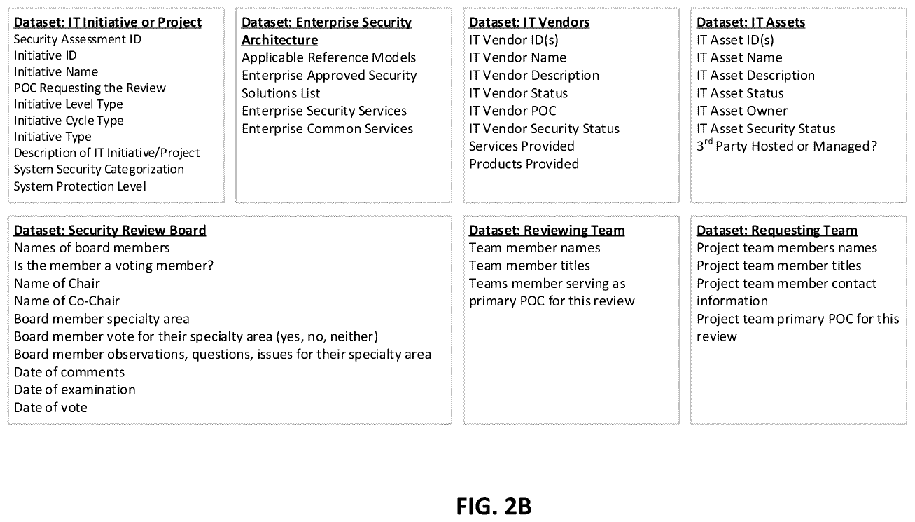

Various embodiments may provide an information set for security architecture and security design as it relates to the IT system, application, operating environment, IT assets. These may include the review's data and records and as further described in FIG. 2B and the Table below.

A software issue form is where the computer will receive inputs from the user, it is where the IT information and security information about the system under review, may be entered into the system and stored in the system, and processed. Various embodiments allow for the creation, storage, management, modification and editing, of the IT relevant and IT information necessary to conduct an examination, assessment, and review of a system's or application or IT asset's security posture, security protections, planned and targeted protections, to determine if they are adequate. Various embodiments leverage the method of enterprise architecture, enterprise information security architecture, and system information security architecture and context as the key information for determining adequacy. Cybersecurity review and assessment of the IT Systems, applications, IT assets, and their operating environments involves the following data which are stored into the invention tool, as follows.

A distinguishing factor between the foundational project management tool and the assessment software tool is the information sets which the system operates on. This is the automation feature whereby information that is manually stored and managed as documents, are now converted into online electronic forms, and whose data are stored in the system's database.

Data Sets of the software tool according to various embodiments are illustrated in FIG. 2A in contrast to a conventional project management tool. A conventional project management tool can be used only for project management, task management, and process management. In contrast, an assessment tool according to various embodiments may be used for broader and more IT focused purposes, such as IT systems, applications, security architecture, IT assets, IT vendors, self-assessments, security designs, IT projects and initiatives, regulatory and policies and so on.

FIG. 2B shows examples of datasets which may be stored and managed by an assessment tool according to various embodiments. These data are not managed and stored by the underlying project management tool. These are the customized data fields which comprise the content of the custom screens and input forms used throughout the review workflows. Each dataset represents a grouping of information which needs to be tracked as part of the cybersecurity review of the IT assets and resources. When the user requests a new review, these are the sets of information which may be input or auto generated into the review. The datasets shown in FIG. 2B include:

IT Project or Initiative Dataset. The project or initiative is the embodiment of all the IT assets and resources of a particular security review. An initiative to bring in new technology into the enterprise, or update existing technology, etc. as it flows through the organization's life cycle may at some point undergo a security review to demonstrate compliance with the organization's requirements and regulations regarding the protection of the enterprise's data, information, systems, peoples.

Enterprise Security Architecture Dataset. These are the elements of enterprise standards and guidelines which the IT assets and resources should demonstrate alignment with, as part of passing the review. The reviewers will perform this assessment.

IT Vendors Dataset. These are data and information are necessary as part of the enterprise managing the IT asset and resources, and are needed by the cybersecurity reviewers to determine appropriate review outcome.

Security Review Board Dataset. In industry, a security board may sometimes be referred to as a security council, the presiding entity in an enterprise which oversees the activities of the security reviews. These are the identifying information about the board or council memberships and presiding chairs and co-chairs. Council or Board members and chairs are the persons who will approve or reject a particular review. An assessment tool according to various embodiments will track each decision maker's comments and decisions or outstanding inquiries regarding the particular review.

Security Review Team Dataset. The security review team interact directly with the project teams (or requesting team) throughout the review process. A team member may be assigned the primary liaison for a particular review. This information is the identifying information for the team.

Requesting Team Dataset. This is the team which requests the review, sometimes also referred to as the project team. This is the identifying information for that team.

An initiative level type could include project, system, application, technology, asset, COTS, component. An initiative cycle type could include new, or update, or increment. An initiative type could include something in the operating environment changes, infrastructure, network, new ones or upgrades or updates, a new system/application is being built, a new solution is being deployed, an existing asset is being re-evaluated, an update or change to existing system or application, a new IT asset is being brought in, IT audit of the security architecture, IT audit of a system/application, within a software development life cycle SDLC, within a system development life cycle SDLC, within a systems engineering life cycle SELC, review and assessment of enterprise architecture as a security control, review and assessment of an enterprise information security architecture as a security control, review and assessment of system level information security architecture as a security control.

Automation of Process Workflow for a Security Assessment and Review refers to the manual steps in the work process which an assessment tool according to various embodiments makes available as workflows that may be executed in an automated fashion.

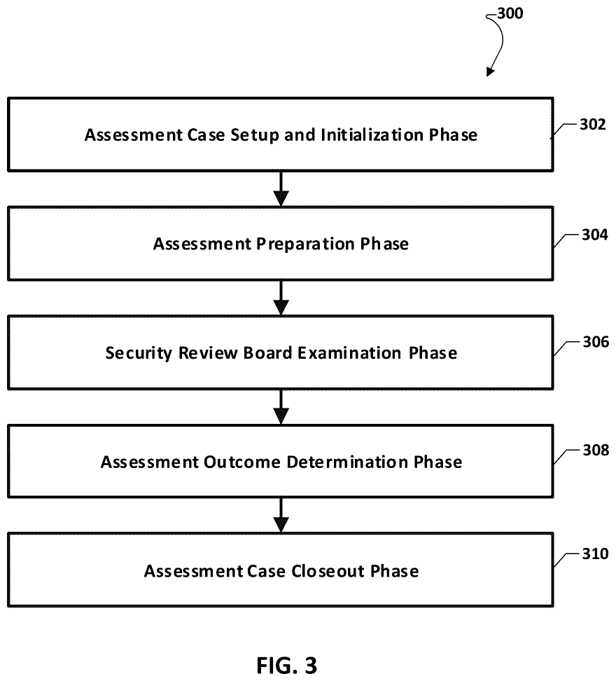

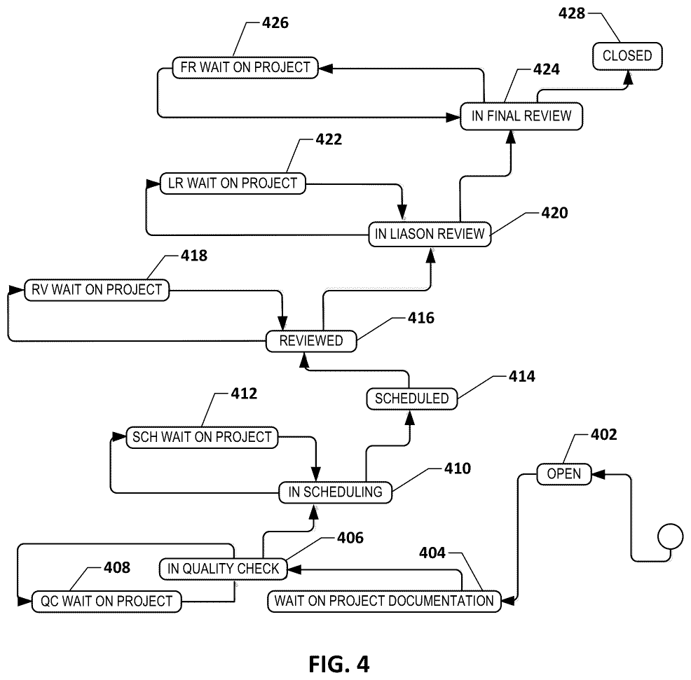

FIG. 3 illustrates a general workflow as may be implemented by an assessment tool according to various embodiments. FIG. 3 illustrates high level “phases” and flow of a Cybersecurity Assessment and Review of an IT System or Application. FIG. 4 illustrates an example of cyber assessment workflows in an assessment tool for conducting a cyber review Type A according to various embodiments. FIG. 4 is described separately below, but some states illustrated in FIG. 4 are referenced in the following description of the workflow illustrated in FIG. 3.

Referring to FIG. 3, in the Assessment Case Setup and Initialization Phase block 302, a blank request form is completed and submitted to the reviewing team for checking. Once checking is completed, the assessment request is then accepted. This is a client/server architecture, so data and events may be sent from the client to the server, the server will transact with the database as needed, and the client will display assessment datasets (as identified above) and will display the current review state which the assessment is in.

During the operations in block 302, the software tool may display an assessment request form and also display “OPEN” as the state 402 in FIG. 4. Next, the assessment server may receive an input event and may display “WAITING ON REQUIRED DOCUMENTATION” as the state 404 in FIG. 4. The assessment server may receive an input done event and may display “CHECKING DOCUMENTATION” or “IN QUALITY CHECK” as the state 406 in FIG. 4. Thereafter, the assessment server may display “REQUEST ACCEPTED” as the state.

In block 304, the Assessment Preparation Phase, the reviewing team must validate the submitted information from the requesting team and there may be some communication exchanges using the ticket's comment field. There may be state transitions as each team has the action to respond, and this is for metrics reporting purposes. The following is a general idea of the software operations progressing through this phase of the assessment.

The assessment server may receive a validation event and may display “VALIDATING DOCUMENTATION AND Q&A” as the state. The assessment server may receive a comment event and may display a comment box. In an assessment tool according to various embodiments, a review ticket has an input field for comments. The assessment server may receive a wait event and may display the “WAITING ON REQUESTING TEAM.”

The assessment server may receive an edit event and may display the datasets and performs updates to the data values as needed. An assessment tool according to various embodiments provides customized input forms for entering review data.

The assessment server may receive a question answered event and may display “VALIDATING DOCUMENT AND Q&A” once again. The assessment server may receive a validation complete event and may display “SCHEDULING REVIEW BOARD EXAMINATION” or “IN SCHEDULING” as the state 410 in FIG. 4. The assessment server may receive a scheduled event and may display “SCHEDULED” as the state 414 in FIG. 4.

In block 306, the Security Review Board Examination Phase, after examination by the board, each voting member will record comments and questions and concerns into an assessment tool according to various embodiments. A series of exchange with the IT Project team ensues as needed, until all the issues have been satisfactorily resolved. The assessment server may receive an edit event and may display the review's software ticket and performs updates to the data values as needed. The assessment server may display “WAITING ON REQUESTING TEAM.”

The assessment server may receive an edit event and may display the review's software ticket and performs updates to the data values as needed. The assessment server may display “WAITING ON REVIEW BOARD.” The assessment server may receive an adjudication event and display “ADJUDICATION COMPLETED” as the state.

In block 308, the Assessment Outcome Determination Phase, the board member votes are recorded and communicated to the requesting team. There is a vote cycle of repeatedly polling board members for their votes until all votes are in. The assessment server may receive a vote event and may display “BOARD MEMBERS VOTING” as the current state. When board members or council members are voting, they may utilize an assessment tool according to various embodiments, which will indicate they are voting. Their votes may be cast into the custom form accompanying the workflow.

The assessment server may receive a vote event and performs updates to the board member dataset as needed and may display the updated dataset. A board member casts their vote into the custom form. The assessment server may receive a done event and may display “VOTING COMPLETED” as the state. This would be the conclusion of the voting workflow.

In block 310, the Assessment Case Closeout Phase, a final validating check and final approval by designated POC is performed. This may entail a cycle of exchanges with board members and requesting teams and review team. After final check, the final approval is issued and the assessment case is mark as closed with the resolution type indicated: approved, not approved, approved with exceptions, approved with pending actions, cancelled. The assessment server may receive finalize event and may display “PERFORMING FINAL VALIDATION” as the state. The assessment server received approved event and may display “APPROVED” as the state. This would be part of the voting workflow. The assessment server may receive a close event and may display “CLOSED” as the state as the state 428 in FIG. 4.

As noted above, FIG. 4 illustrates an example of cyber assessment workflows in an assessment tool for conducting a cyber review Type A according to various embodiments. An assessment tool according to various embodiments may provide at least three different types of reviews: a Standard Review, an Enhanced Review, and a Full Review. Each review type will have its own workflow. FIG. 4 is an example of the workflow for a cybersecurity review.

At each phase and stage, allows for project teams and review teams to collaborate, share comments and information, and each step is progressed until the Closed stage is reached at which time the project's security review has either been approved or rejected. Through the flow, review data and artifacts are stored with the ticked or as attachments to the ticket, thereby eliminating the need to separate manually managed repositories.

When a review request is first generated, the review ticket is created and put into an OPEN state 402. The OPEN state means this review is awaiting assignment to a reviewer.

In the WAIT ON PROJECT DOCUMENTATION state 404, the review has been assigned to a reviewer and the review team is waiting for the project team to complete and submit the project documentation needed to do the review, and this includes input into the custom forms for requested information.

In the IN QUALITY CHECK state 406, the project team has completed and submitted information needed for the review, and the review team is doing quality check on what has been submitted.

In the QC WAIT ON PROJECT state 408, there were quality issues found and the documentation has been returned to the project team for correction. The review team is waiting on the corrections from the project team.

In the IN SCHEDULING state 410, either there were not quality issues found, or the project team has made corrections and their resubmission has been cleared, and this review is now ready to be scheduled onto the calendar.

In the SCH WAIT ON PROJECT state 412, the review session has been scheduled and the review team is waiting on confirmation from the project team.

In the SCHEDULED state 414, the project team has confirmed the review appointment.

In the REVIEWED state 416, the review session has been held and feedback has been provided to the project team, including decisions from the review board members, any open issues that still need to be addressed and resolved.

In the RV WAIT ON PROJECT state 418, the system is waiting on the project team to complete their action items from the review session and provide them back to the review team and review board members.

In the IN LIASON REVIEW state 420, the actions of the review have been completed and all necessary information has been provided. The Liaison (the assigned reviewer) performs a final look over.

In the LR WAIT ON PROJECT state 422, during Liaison review the reviewer had additional interaction with the project team and are waiting on their response.

In the IN FINAL REVIEW state 424, there is a designated member of the board or council who records the final outcome. In final review, the designated official conducts a check over of the review.

In the FR WAIT ON PROJECT state 426, The designating official had additional interactions with the project team and are awaiting their response.

In the CLOSED state 428, the review has been completed and recorded.

In addition to the elements FIG. 4, an assessment tool according to various embodiments may provide provides the ability to implement sub-processes and associated forms and their data, such as a typical security artifact called POA&M (Plan of Action and Milestones) for tracking issues along the way during the review process.

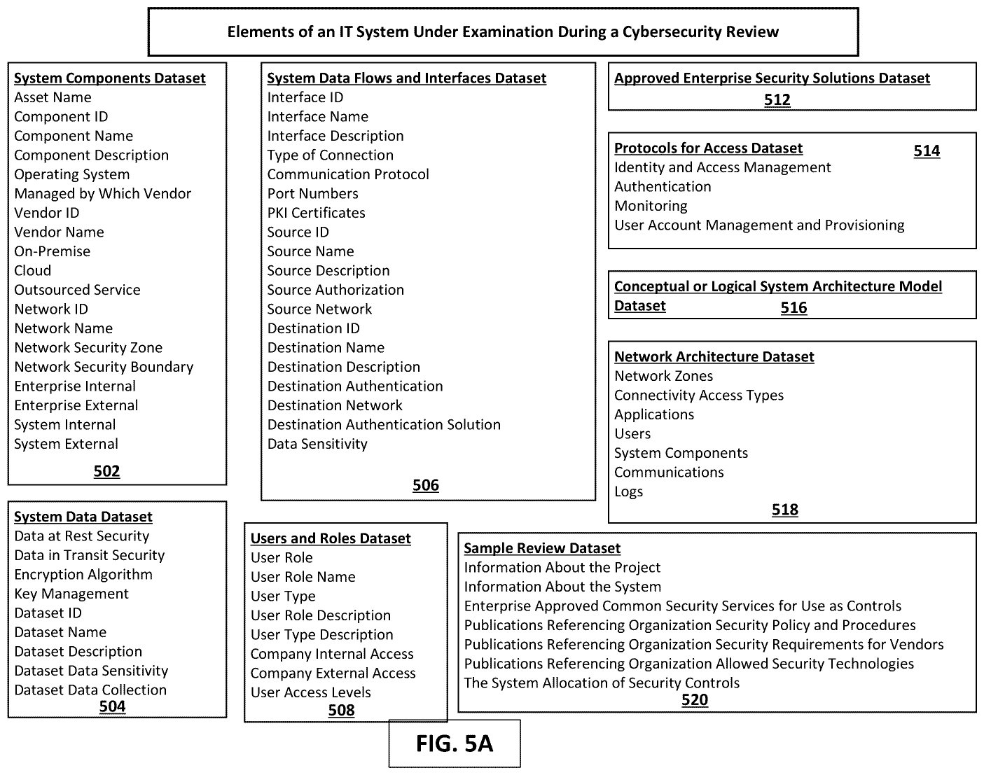

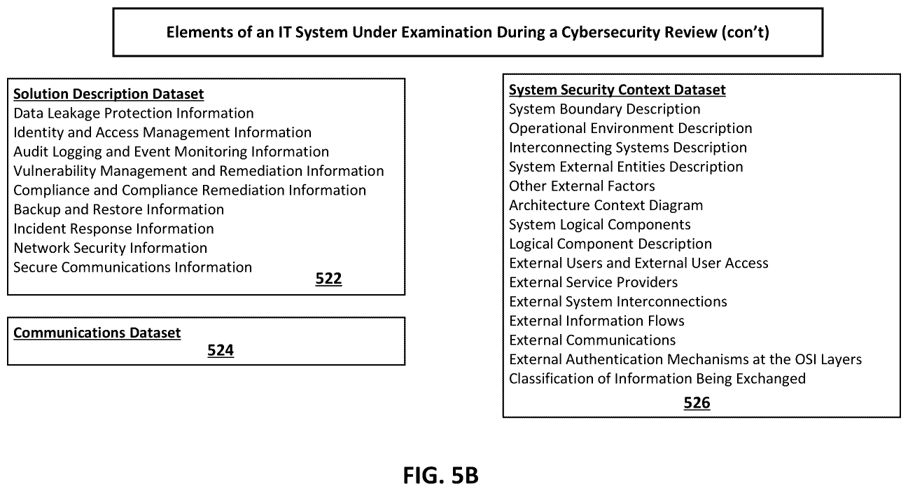

FIGS. 5A and 5B illustrate an example data set for the system level security architecture. A cybersecurity review of an IT system involves examination of system and system relevant information. FIGS. 5A and 5B show extensively the customization of the input forms for an assessment tool according to various embodiments that include the illustrated datasets. The Project Teams and the Reviewers may input various ones of these data and information sets. Some datasets may also be added to the review as file attachments. The input fields may be of various data types to include text, diagrams, numbers, or links. Some customizations of the tool's input forms may include the following.

The System Components Dataset 502 refers to an IT Component within the IT System under review. The data items included are needed for various identifying purposes of the component, what network the component resides on.

The System Data Dataset 504 includes certain information about the data relevant to the system under review, such as data residing in the system, data processed by the system, data exchanged with other entities, assurance level and such protection relevant information of the data.

The System Data Flows and Interfaces Dataset 506 provides data, such as communication protocol, type of connection, the source and the destination, and data sensitivity, that the reviewers need to ensure is going into and out of the system in a secure fashion in the context of a security review.

The Users and Roles Dataset 508 may provide the types of users who access the system, their privileges, whether access if from internal to the organization or external that the security review must examine.

The Approved Enterprise Security Solutions Dataset 512 may come in various forms to include just a textual description, a diagram, or some artifact representation in a file that summarizes and describes the security solutions incorporated into the system.

The Protocols for Access Dataset 514 may include information regarding access related technologies in use such as authentication, monitoring, user provisioning that reviewers will need to examine.

The Conceptual and Logical System Architecture Dataset 516 may be a text description, or a diagram.

The Network Architecture Dataset 518 may include information that provides various factors about the network over which the system will reside and interface with other systems or users. Such as an identifying network zone, connectivity type, logs and audit information recording access attempts.

The Sample Review Dataset 520 provides high level summary of information needed to conduct the review, such as identifying information about the project, the system, referenced publications of the organization containing policies and procedures, what security controls the system implements.

The Solution Description Dataset 522 may include descriptive factors of the security solutions embedded into the system, such as data leakage protection, incident response information, network security information, secure communications information.

The Communications Dataset 524 may be a text description or diagram as means of conveying additional information about the communications aspects of the system.

The System Security Context Dataset 526 includes various aspects of the security of the system, such as a system boundary description, the operational environment description, any interconnecting systems, any external entities that are relevant, the users, the information flows, data classifications.

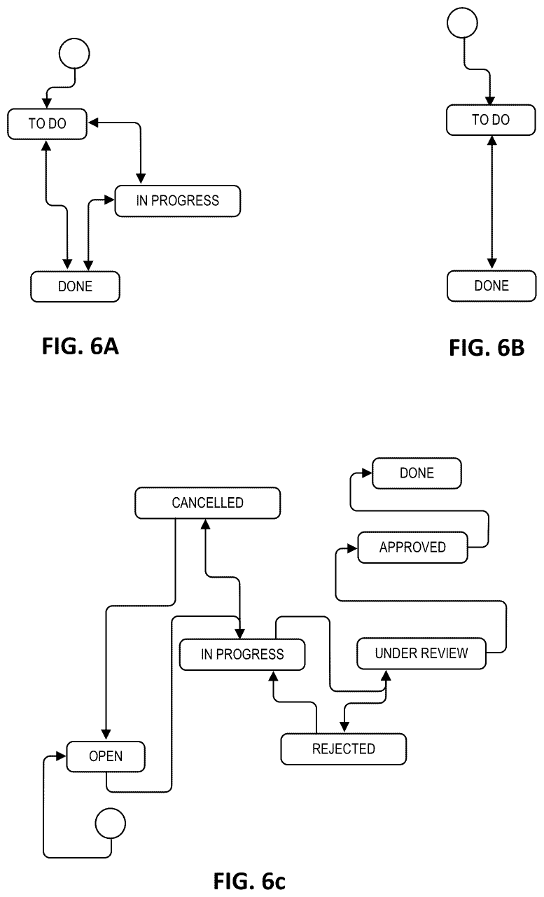

FIGS. 6A-6C show workflows provided by the underlying technology which is a Project Management Tool. These workflows are generic to the nature of project management, task management, and process management.

The foregoing method descriptions and the process flow diagrams are provided merely as illustrative examples and are not intended to require or imply that the operations of various embodiments must be performed in the order presented. As may be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments may be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method performed by a processor of a computing device for supporting cybersecurity reviews of an enterprise's IT systems, software, and assets, comprising:
accessing, by the processor, a cybersecurity assessment tool implemented on a project management platform;
customizing, by the processor, the project management platform to extend its functionality to include cybersecurity assessment features by extending capabilities of a process management project type, creating customized workflows for security IT reviews, adding custom fields to generic screens, using automated workflows and custom forms from data entry, processing through assigned workflows enabling reviewer and team input, and storing reports as official case records assessable post-review;
receiving, by the processor, input data related to an IT system under review, wherein the input data includes at least security architecture and design information;
automatically conducting, by the processor, a cybersecurity assessment of the IT system based on the input data;
generating, by the processor, an assessment report that includes an outcome of the cybersecurity assessment; and
storing, by the processor, the assessment report in a database accessible by the cybersecurity assessment tool.

2. The method of claim 1, wherein the cybersecurity assessment tool is configured to integrate with and retrieve information from other enterprise systems, including at least an IT asset management server, an IT vendor management server, and an IT project server.

3. The method of claim 1, further comprising providing, by the processor, a centralized repository for information necessary for conducting the cybersecurity assessment, wherein the centralized repository includes data on security architecture and security design of the IT system under review.

4. The method of claim 1, wherein the cybersecurity assessment tool provides customized workflows for conducting the cybersecurity assessment, the workflows including a comprehensive assessment workflow, a basic assessment workflow, and a custom assessment workflow.

5. The method of claim 1, further comprising automating, by the processor, the organization and management of review data and artifacts associated with the cybersecurity assessment, wherein the automation includes the use of custom forms for data entry and storage in the system's database.

6. The method of claim 1, wherein the cybersecurity assessment tool is further configured to serve as an official System of Record (SOR) for the cybersecurity assessment, storing all related data, decisions, and comments made during the assessment process.
